(19) United States
(12) Patent Application Publication
(10) Pub. No.: US 2024/0124990 A1
(43) Pub. Date: Apr. 18, 2024

(54) Water Splitting Electrolytic Chamber Design

(71) Applicant: Robert Volk, Martinez, CA (US)

(72) Inventor: Robert Volk, Martinez, CA (US)

(21) Appl. No.: 18/526,883

(22) Filed: Dec. 1, 2023

Related U.S. Application Data
(60) Provisional application No. 63/412,494, filed on Oct. 2, 2022.

(51) Int. Cl. C25B 9/65; C25B 1/04; C25B 11/042

(52) U.S. Cl. CPC C25B 9/65; C25B 1/04; C25B 11/042

(57) ABSTRACT

This nonprovisional patent application discloses an innovative electrolytic chamber assembly and associated methods for generating on-demand hydrogen-oxygen gases. The assembly comprises a series of metal electrode plates, neutrals, and terminal assemblies meticulously designed for efficient hydrogen and oxygen gas production. The inventive design includes precise milling, spot welding, and sealing techniques to ensure optimal performance and prevent leaks.

Furthermore, this application introduces the concept of a complete system utilizing the advanced electrolytic design details in this patent, variations in the power supply methods for the electrolytic chamber, and the integration of engine sensor signal capture and adjustment means, both manually and through software driven applications. The power supply methods address issues related to voltage, ampere, and frequency regulation and efficiency. It describes a CCPWM controller (Constant Current Pulse Width Modulator) utilizing capacitors and circuitry for both lower and higher voltage systems, enhancing the production of hydrogen and oxygen gases. Additionally, it explores the utilization of three-phase AC power from engine driven alternators, providing superior efficiency for larger electrolytic chamber designs.

Beyond industrial applications, the invention explores novel uses of the generated and filtered hydrogen-oxygen gas mixture in areas such as health care, fitness, and emissions reduction. Preliminary testing indicates promising results in improving lung capacity (as seen in post covid tests), enhancing athletic performance, work energy levels, and topical skin treatments as well as evidence of some sub dermal treatment benefits, and direct treatment of water to enhance oxygen and hydrogen levels which can be used for drinking, agriculture and hydroponics, animal husbandry, manufacturing, and more. The proven ability in testing shows greatly reduced emissions from all combustion engines including gasoline/petrol, diesel, CNG, biodiesel, and LPG in cars, trucks, big rigs, even reducing emissions in diesel generator sets.

This patent application encompasses a range of inventive variations and features that can be claimed independently or in combination, ensuring its adaptability to diverse applications and industries. The disclosed innovations expand the horizons of hydrogen-oxygen gas production and its applications, promising advancements in efficiency, performance, and environmental impact.

### CROSS-REFERENCE TO RELATED APPLICATIONS

This application relates back to provisional application U.S. 63/412,494 filed on Oct. 2, 2022, and is incorporated in its entirety.

### BACKGROUND OF THE INVENTION

This nonprovisional patent pertains to improvements in the design of electrolytic chamber assemblies using a formed box means and plate holding means that are used for real time electrolytic systems and the many other variants utilizing a formed box means and plate holding means to comprise an electrolytic chamber assembly.

The improved design can be used for the purpose of splitting water into its base atoms of hydrogen and oxygen in real time and in applications where an efficient and compact system is required, such as vehicles with combustion engines, electrical generators, heating systems, and health aid equipment. In these patents we are taught that a formed box and plate holder are assembled in a stacked plate and gasket configuration with gaskets and plates stacked alternately, with gaskets and plates held in position in a box configuration by means of a series of bolts and nuts.

In practice the box, plates, and gaskets are held together as an assembly by the series of bolts and nuts with the gaskets being compressed by the nuts-and-bolts system tightened to a specific torque. In practice an electrolytic chamber assembly is mounted near a reservoir filled with water mixed to a specific ratio with an electrolyte and plumbed into the electrolytic chamber using a series of hoses or tubing, and specific fittings. To prevent leakage of the water and electrolyte mixture, the gaskets must be compressed to a certain compressive value. The electrode plates of the electrolytic chamber are connected electrically to a particular power source which sends a metered voltage and current through the plate and gasket assembly.

Problematic with the current design, as the electrolytic chamber is powered up, water and electrolyte solution along with the metal plates begin to retain heat from the applied power and means. When the system is powered down, the water and electrolytic solution, plates, and gaskets cool down. This constant thermal cycling causes expansion and contraction between the plates and gasket assemblies, eventually causing the nuts and bolt fasteners to loosen, resulting in leaks and resulting alkaline salts corrosion from the electrolytic solution. Due to the dissimilar thermal properties of metal plates and compressive gaskets as shown in the reference patents, constant maintenance and occasional replacement of gaskets is required.

Problematic also with the current design, is the need to compress the gaskets and plates in a consistent manner to prevent leaks. To accomplish this, the end plates of the box must be dense and stiff enough to retain shape for the proper compression of the gaskets along their entire perimeters, and the nut and bolt assemblies must be closely placed around the perimeter of the box means in a method to prevent warpage and subsequent leaking. The requirement of the multiple bolt/nut assemblies and stiff end plates result in a heavy and bulky electrolytic assembly which requires frequent maintenance to prevent the bolts and nut assemblies from leaking.

In practice, the current design passes a direct current voltage at low current into the electrolytic chamber consisting of box means and plate and gasket assembly, through the electrical connections to electrodes. The current design is typically hooked up electrically in a series configuration with positive and negative electrodes that have electrical connections to a power source, and a series of neutral plates in between the electrodes the number required to best keep the system operating at approximately 2 volts per space in between the plates. The water and electrolyte solution circulates between these plates. As the voltage/amperage and frequency are applied to the electrodes and neutral plates, the water is broken into its base atomic structure of both hydrogen and oxygen, which circulate out of the electrolytic chamber into a reservoir where they are separated, filtered, and sent to the end use.

Problematic with the current design is the flow rate and circulation of the water as well as the existing flow rate of the saturated gases. To allow the water and gas flow, current design using the compressed gasket and plate means, requires holes between plates internally. A balance of hole size versus edge current leakage is a mitigating factor in current designs. A larger set of holes internally allow for better water and gas circulation, allowing for cooler operation. Concurrently, larger holes present more sharp edge exposure and resulting edge current leakages. When applied voltages and currents flow into the plates, the goal is for most of that energy to be used in the electrolytic process for best efficiencies. The electrical current typically passes through the electrolytic solution in the areas of least resistance, from one plate to the next. If you have flat metal plates stacked and held in a parallel configuration, the electrical resistance is generally equal throughout the exposed area of the plates. However, if there is a sharp or exposed edge of metal in those plates, the electrical pulses will seek the path of least resistance through the electrolytic solution, and some of that energy will dissipate in what is referred to as edge current leakage, effectively shunting away energy that could be used to break down the water molecules, but instead is converted to heat and efficiency loss.

The novel concept of this patent that I have invented eliminates all internal holes from the plates significantly reducing the electrical losses due to edge current leakage, assisting in the prevention of water spoilage and evaporation that are the results of overheating the electrolyte and water solution. The improved design eliminates the use of all compressive gaskets, and the nuts-and-bolts assemblies needed to clamp the system to prevent leaks, resulting in a much lighter and compact assembly, elimination of thermal cycling expansion and contraction issues, and significantly reducing manufacturing costs. The novel design integrates a series of grooves integrated into the box sides and internal, upper and lower plate retainers which encase and cover all exposed edges of the internal plates significantly reducing edge current losses. The improved design also increases water and gas circulation through improved fluid dynamics consisting of novel grooves parallel to the plates, or plurality of holes arranged internally between each plate, reducing heat build up and improving gas production.

It is a further novel concept of this patent to eliminate the clamping arrangement in the box means, and the compressive gaskets, by integrating the plate and retainer groove assemblies within a plastic box means, with the said box adjoining surfaces chemically or ultrasonically welded at assembly. With the entire box means and retainer rings and grooves made of the same materials, and with substantial clearances in the grooves for the metal plates to thermally expand and contract, plate spacing will remain optimally parallel and thermal cycling will not affect the sealing capabilities of this improved design, reducing costs to manufacture and maintenance of the end user.

My improved electrolytic chamber design can be utilized as an aftermarket chamber for the various electrolytic designs that suffer from elements addressed by this new design concept.

A compact low weight electrolytic chamber assembly is disclosed. The lower tare weight design includes a sealed system to provide lower maintenance for the user and easier installation procedures, as well as more efficient manufacturing advantages. Moreover, the internal assemblies are constructed to allow improved water flow over the internal plates resulting in better fluid dynamics and better heat transfer. The accurate spacing using grooved upper and lower plate retainers and grooves integrated into the box-like container, result in rigidly aligned plates and spaces unaffected by thermal cycling or compressive gaskets. This is especially advantageous for efficient production of the base atomic gases of hydrogen and oxygen created when power is applied to the electrical terminals provided. Such use prevents water spoilage and overheating from excess current leakage that is amplified with exposed edges of the metal plates in a water splitting electrolytic chamber. Such use offers further advantages by eliminating the weight and cost of multiple stainless-steel bolts and nuts and gaskets, and the concurrent leakage that occurs from them due to the consistent thermal cycling of the chamber assembly. It ensures consistent performance and long-term low maintenance for the electrolytic chamber and supporting systems.

This nonprovisional patent pertains to improvements in the design of electrolytic chamber assemblies using a formed box means and plate holding means that are used for real time electrolytic systems and the many other variants utilizing a formed box means and plate holding means to comprise an electrolytic chamber assembly.

The improved design can be used for the purpose of splitting water into its base atoms of hydrogen and oxygen in real time, on demand, and in applications where an efficient and compact system is required, such as vehicles with combustion engines, electrical generators, heating systems, and health aid equipment. In these patents we are taught that a formed box and plate holder are assembled in a stacked plate and gasket configuration with gaskets and plates stacked alternately, with gaskets and plates held in position in a box configuration by means of a series of bolts and nuts.

In practice the box, plates, and gaskets are held together as an assembly by the series of bolts and nuts with the gaskets being compressed by the nuts-and-bolts system tightened to a specific torque. In practice an electrolytic chamber assembly is mounted near a reservoir filled with water mixed to a specific ratio with an electrolyte and plumbed into the electrolytic chamber using a series of hoses or tubing, and specific fittings. To prevent leakage of the water and electrolyte mixture, the gaskets must be compressed to a certain compressive value. The electrode plates of the electrolytic chamber are connected electrically to a particular power source which sends a metered voltage and current through the plate and gasket assembly.

Problematic with the current design, as the electrolytic chamber is powered up, water and electrolyte solution along with the metal plates begin to retain heat from the applied power and means. When the system is powered down, the water and electrolytic solution, plates, and gaskets cool down. This constant thermal cycling causes expansion and contraction between the plates and gasket assemblies, eventually causing the nuts and bolt fasteners to loosen, resulting in leaks and resulting alkaline salts corrosion from the electrolytic solution. Due to the dissimilar thermal properties of metal plates and compressive gaskets as shown in the reference patents, constant maintenance and occasional replacement of gaskets is required.

Problematic also with the current design, is the need to compress the gaskets and plates in a consistent manner to prevent leaks. To accomplish this, the end plates of the box must be dense and stiff enough to retain shape for the proper compression of the gaskets along their entire perimeters, and the nut and bolt assemblies must be closely placed around the perimeter of the box means in a method to prevent warpage and subsequent leaking. The requirement of the multiple bolt/nut assemblies and stiff end plates result in a heavy and bulky electrolytic assembly which requires frequent maintenance to prevent the bolts and nut assemblies from leaking.

In practice, the current design passes a direct current voltage at low current into the electrolytic chamber consisting of box means and plate and gasket assembly, through the electrical connections to electrodes. The current design is typically hooked up electrically in a series configuration with positive and negative electrodes that have electrical connections to a power source, and a series of neutral plates in between the electrodes, the number required to best keep the system operating at approximately 2 volts per space in between the plates. The water and electrolyte solution circulates between these plates. As the voltage/amperage and frequency are applied to the electrodes and neutral plates, the water is broken into its base atomic structure of both hydrogen and oxygen, which circulate out of the electrolytic chamber into a reservoir where they are separated, filtered, and sent to the end use.

Problematic with the current design is the flow rate and circulation of the water as well as the flow rate of the gases as they exit the electrolytic chamber. To allow the water and gas flows, current designs using the compressed gasket and plate means, requires holes between plates internally. A balance of hole size versus edge current leakage is a mitigating factor in current design. A larger set of holes internally allow for better water and gas circulation, allowing for cooler operation. Concurrently, larger holes present more sharp edge exposure. When applied voltages and currents flow into the plates, the goal is for most of that energy to be used in the electrolytic process for best efficiency. The electrical current typically passes through the area of least resistance, from one plate to the next. If you have flat metal plates stacked and held in a parallel configuration, the electrical resistance is comparatively equal throughout the exposed area of the plates. However, if there is a sharp or exposed edge of metal in those plates, the electrical pulses will seek the path of least resistance and some of that energy will dissipate in what is referred to as edge current leakage, effectively shunting away energy that could be used to break down the water molecules, but instead is converted to heat and efficiency losses.

### Definitions

Invention: The term “invention” is used herein merely to relate to the inventive idea that is the subject of this nonprovisional Patent Application to refer to the “concept” being presented. The term “invention” shall not be construed to mean the “literal and legal” translation of the term “invention”; instead it shall pertain to the “concept” being presented. The term “invention” is used herein merely to relate to the inventive idea that is the subject of this nonprovisional Patent Application to refer to the “concept” being presented. The term “invention” shall not be construed to mean the “literal and legal” translation of the term “invention”; instead it shall pertain to the “concept” being presented.

Article: We shall refer to the term article to define any physical object that may have the characteristics of the inventive idea.

If you refer to a term that is not commonly known then DEFINE it here. For example see below . . .

Peanut: The term “Peanut” shall refer to a small wireless electronic device that is injected into the bloodstream of a patient to monitor oxygen content.

### SUMMARY OF THE INVENTION

The novel concept of this patent that I have invented eliminates all internal holes from

the plates significantly reducing the losses due to edge current leakage. The novel design integrates a series of grooves integrated into the box sides and plate retainers to cover all edges of the internal plates, also significantly reducing edge current losses while concurrently improving the production of the essential gases produced and reducing the amount of water/electrolyte solution consumed in the process.

The improved design eliminates the use of all compressive gaskets, and the nuts- and-bolts assemblies needed to clamp the system to prevent leaks. Removing these assemblies reduces the weight and cost of the electrolytic chamber. Removing the need to clamp metal plates and gaskets from the assembly also allows thinner metal plates to be used, reducing costs to manufacture and reducing overall weight of the chamber assemblies.

The improved design also increases water and gas circulation significantly by the placement of novel grooves parallel to the plates and/or a plurality of holes, and arranged internally between each plate, further reducing heat, improving fluid dynamics, electrical efficiencies, and gas production.

It is a further novel concept of this patent to eliminate the clamping arrangement in the box means, and the compressive gaskets, by integrating the plate and retainer groove assemblies within a plastic box means, with the said box joints and adjoining surfaces, chemically or ultrasonically welded at assembly. With the box, plate retainers and grooves made of the same materials, and with substantial clearances in the grooves for the metal plates to thermally expand and contract, plate spacing will remain optimally parallel and thermal cycling will not detrimentally affect the sealing capabilities of this improved design, reducing costs to manufacture and maintenance of the end user.

My improved electrolytic chamber design can be utilized as an aftermarket chamber for the various electrolytic designs that suffer from elements addressed by this new design concept.

The present invention further comprises methods of manufacture. These methods may include not only those associated with creating the constituent components (e.g., as detailed below) but also their assembly to prepare a new (or refreshed) electrolytic chamber for use.

### BRIEF DESCRIPTION OF DRAWINGS

FIG. 1 Pictures a front view, top view, and right-side view of the electrolytic chamber fully assembled including water inlet and gas outlet:

FIG. 2 is an isometric view of FIG. 1:

FIG. 3 is an isometric view of a preferred embodiment of the box means of the electrolytic chamber:

FIG. 4 shows an isometric view of the electrolytic chamber with front view and side view removed for clarity to understand the relationship between the box, the metal plate stack, and plate retainer means inside;

FIG. 5 shows a front view, top view, and bottom view of FIG. 4

FIG. 6 is an isometric view of the metal plate stack assembly the top and bottom plate retainers, the inner and outer bottom retainer supports, and the bottom plate of the box means;

FIG. 7 shows a front view, top view, side view, and bottom view of the metal plate stack assembly shown in FIG. 6;

FIG. 8 shows an isometric view of the bottom plate retainer, the inner and outer supports, and the bottom plate of the box;

FIG. 9 is a front view, top view, and bottom view of FIG. 8, and includes a detailed cross section of the bottom plate retainer, supports and bottom plate;

FIG. 10 shows a simplified isometric view of the left side of the box and its relation to the bottom plate retainer, the supports, the bottom plate, and two metal plates (an electrode and neutral plate);

FIG. 11 is an enlarged detail of section A referred to in FIG. 10;

FIG. 12 shows an isometric view of the electrolytic chamber with the front plate, right side plate, and back plate removed for clarity. It is a simplified drawing having only 5 of the metal plates showing to help clarify the electrical connections and the fluid flow direction detailed in FIG. 13 and FIG. 14;

FIG. 13 shows a front view, top view, right side view, bottom view of FIG. 12, and a section detail view A-A to clarify the water flow and gas flow channels including the barbed hose fittings of top and bottom plates. The electrical connections from the electrodes to the protruding terminals of the top plate are also detailed as a preferred embodiment.

FIG. 14 shows an isometric view of the electrolytic chamber with the front plate removed and the top plate invisible, to clarify the electrical connections between the electrode metal plates and the protruding terminals of the top plate,

FIG. 15 shows a detailed drawing of the top plate of the electrolytic chamber and the precisely milled holes for the terminal protrusions, including a square hole for the shank of the bolt and a recessed area for the O-ring compression and containment, as well as the military grade sealing nut placement,

FIG. 16 shows a detailed drawing of the stainless steel Carriage bolt, O-ring, and military spec sealing nut designed to prevent leaks. least one specification heading is required.

FIG. 17 shows a general schematic layout for the health aid machine utilizing a light weight power supply that operates on 110 volt line voltage and does not require a transformer to step voltages down for the electrolytic chamber assembly and system. The gases produced can be used for breathing, water treatment, and/or the treatment of topical and subdermal applications such as cysts, eczema, moles, and more as evidenced in part in FIG. 23 and FIG. 24

FIG. 18 shows an alternative method of powering the electrolytic chamber system using a unique connection to a vehicle's alternator, bypassing the voltage regulator and tapping into the available generated 3 phase ac current at a higher voltage (usually between 36 and 48 volts in our tests). Voltage is semi-auto controlled by voltage requirement of electrolytic cell chamber 10 via spacing of internal plates @ approx. 2 volts per space. Pulse is controlled by Run Capacitor circuitry.

FIG. 19 shows a schematic for an improved controller used in the operation of the electrolytic chamber which has been shown to increase engine efficiency when introducing the hydrogen and oxygen gas into a vehicle engine and/or electronically controlled generator system.

FIG. 20 shows an example of a customer emissions report using our electrolytic chamber and system on his vehicle. The lower three photos are graphic representations of the results showing dramatic reductions in HC (Hydrocarbons), CO (Carbon Monoxide), and NOX (Nitrogen Oxide). The charts show maximum allowed, normal emissions for that vehicle, and emissions when our system was turned on.

FIG. 20a shows an example of the dual core commercial system being tested on a large diesel backup generator at a steel plant. There were multiple witnesses and a Cummins Engineer from the nearby lab to witness the results. The photos show before and after treatment using our electrolytic cells and commercial unit.

FIG. 21 and FIG. 21a shows an alternative embodiment of the top lid of the electrolytic chamber with the underside of the lid having a machined ellipse to improve fluid dynamics as the gas exits the top of the chamber container.

FIG. 22 shows an alternative embodiment of the electrolytic chamber design illustrating a round or elliptical container box which can be used as an injection mold part to increase production and lower costs to the manufacturer. The box is shown parted in the middle with plates and grooves exposed for illustration, and mounting holes molded into the casing.

FIG. 22a shows an alternative embodiment of a stainless steel electrode terminal connection extending out of the box lid and sealed by a terminal compressive seal assembly attached to the lid and sealed with an a-ring or molded gasket to prevent leaks.

FIG. 23 and FIG. 24 show examples of preliminary testing of the health unit mentioned in this patent, referring specifically to the topical application of the gases under pressure, to aid in the healing of skin issues. FIG. 23 is an example of the testing of the tropical application of hydrogen-oxygen gases using low pressure. The gases were inserted by a hose coming from the Health Aid machine mentioned in the patent, and injected into a flexible container which enveloped the entire hand, inflating the container at low pressure, allowing the excess gases to flow out. Periods of exposure/treatment ranged from 30 minutes to one hour. 3-4 times per week. No additional medications, creams, or pharmaceuticals were used. Prior to this experiment, the eczema on the hand had been a factor for over 20 years. Prescription medications, lotions, creams, etc, had been tried which only masked the effect, but did not cure it. The only thing that helped was an over the counter cream to help moisturize and relief the pain. It continued spreading and getting thick for over 20 years. FIG. 23A is a photo showing the extent of severity without creams or lotions on it. FIG. 23B is a photo showing the eczema started to return to the ring finger and began progressing. This photo was taken on Sep. 21, 2023. FIG. 23C is a photo showing the eczema is almost gone after one month of treatment. The photo was taken Oct. 10, 2023 and the treatment will continue until completely gone this time. All itching, cracking, thickness of skin are gone and the skin now is fresh and pink, soft and supple. FIG. 24 is another example of progressive treatment of a facial mole using hydrogen oxygen gases. FIG. 24A is a photo (taken on Sep. 26, 2023) showing the beginning of topical treatment of the mole on face using health aid machine of the present patent. No other medications or pharmaceuticals used. FIG. 24B is a photo (taken Sep. 26, 2023) of a close up of the mole. FIG. 24C is a photo (taken Sep. 28, 2023) showing the 3rd day of treatment. Mole is puffy and the patient can feel something happening deep inside, like a tightening. FIG. 24D is a photo (taken Sep. 29, 2023) shows the 4th day of treatment. Area around mole seems to be drying out. A redness appeared above the mole with 2 white seed like postules appearing. The patient can feel something happening deep under the skin, FIG. 24E is a photo (taken Oct. 21, 2023) showing all inflammation and redness is gone. Mole is almost gone after daily treatment raging from 15 minutes to 1 hour. FIG. 24F is a photo (take Oct. 23, 2023) showing the mole is almost completely gone after one month. Treatments continue around the perimeter as well as directly on the mole. These are preliminary tests only and further testing with independent researchers will be pursued. The figures provided herein are not necessarily drawn to scale, with some components

and features exaggerated for clarity. Of these:

### DETAILED DESCRIPTION OF THE INVENTION

Exemplary embodiments of the invention are described below. Reference is made to the

examples in a non-limiting sense. They are provided to illustrate more broadly applicable aspects of the present invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. The drawings illustrate a rectangular box made of individually machined pieces, but for manufacturing advantage the box can be injection molded as one piece with said improvements, and the top or side could be injection molded and chemically or ultrasonically welded to the box after assembly. The plate retainers could be molded as shown or with shaped holes rather than oval or rectangular grooves. The entire electrolytic parts assembly and box may also be modified in shape such as circular, oval, or other geometric shape. The electrical terminals are shown as stainless steel carriage bolts, nuts and gasket, but in practice they could be made of a different metal, different sealing characteristics, or molded into the lid similar to a battery box. All such modifications are intended to be within the scope of the claims made herein.

The drawings illustrate an exemplary embodiment of an electrolytic chamber means using a Chemically or ultrasonically weldable media consisting of part or parts to form the body of the container and a separate part or parts forming the top piece with a 316L stainless steel or similar metal plate stack contained therein secured to a chemically compatible metal plate containment system utilizing a series of shallow grooves to secure the metal plates in a secure and parallel fashion with precise spacing, and a series of deep grooves or slots that penetrate the plate retainers on the bottom and top as to allow ample water flow between the metal plates without exposing the edges to edge current losses.

Other embodiments may employ another insulative media, such as Delrin, Teflon or other high heat resistant plastics with proper insulative properties, as well as chamber body construction utilizing other manufacturing methodologies such as blow molded, deep draw, and or injection molding assemblies. Parts can be chemically welded, glued or adhered with properly specified adhesives, ultrasonically welded, or molded as per best methods for permanent sealing of the electrolytic chamber to prevent leaks.

More generally, with grooves integrated into the sides of the electrolytic chamber and the metal plates secured in upper and lower retainers with precisely configured water channels to allow generous flow of water and electrolyte solutions, it is possible to manufacture a lighter, more compact electrolytic system which can be permanently sealed against leaks, similar to a present-day battery box in vehicles. The advantage of the reduction in tare weight is that the plate holding means can be optionally integrated into the chamber structure so that the system functions more efficiently, is cheaper and quicker to manufacture, and easier for the end user to install and maintain.

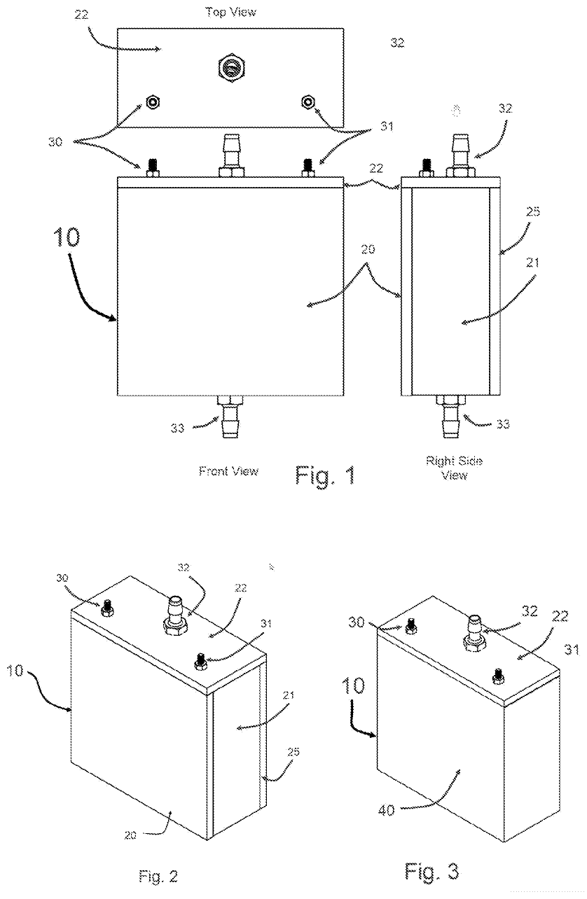

Turning to FIG. 1, it shows a front top and side view of one embodiment of the electrolytic chamber. In this embodiment, The chamber body consists of precisely manufactured parts including the front plate 20 the back plate 25 the right side plate 2, the left side plate 24, and the top plate 22. Also shown are the fluid and gas exchange nozzles installed or molded into and extending outward from the top plate 22 and the bottom plate 23. The fluid nozzle 33 is installed or molded in the bottom plate 23, and the gas nozzle 32 is installed or molded in the top plate 22. These nozzles are shown in the current embodiment as high temperature molded plastic hose fittings manufactured with hose barbs for the connection of hoses to transfer fluids into and gases out from the electrolytic chamber design. The molded fittings in this embodiment are threaded with an NPT thread configuration and installed with an adhesive sealant to prevent leaks. Alternatively, hose barb fittings 32 and 33 could be manufactured of similar plastic as the box container parts 22 and 23 and be ultrasonically welded or chemically welded in place. Alternatively, the hose barb fittings could be molded into the box and lid assemblies. Alternatively the hose barb fittings could be substituted with compressive hose fittings or push tubing fittings if proper heat and gas specifications are met.

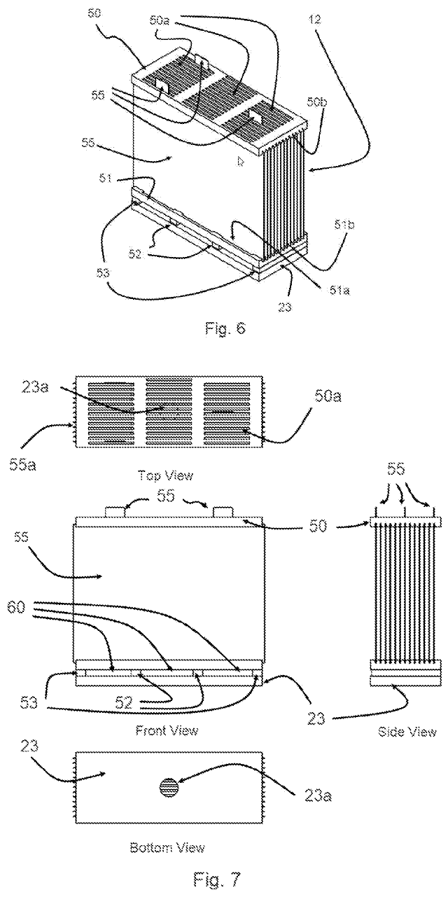

In this embodiment, the front panel 20, back panel 25, left side panel 24, right side panel 21, and bottom panel 23, are precisely fit together and chemically welded. The plate stack assembly 12 shown in FIG. 6 is inserted into the welded box container and electrical connections established to the positive terminal assembly 30 and negative terminal assembly 31 in top plate 22, prior to the top plate 22 being welded to the box container assembly. Alternatively the order of assembly and position of the electrodes could be changed and are covered in the scope of this patent. In FIG. 2, an isometric view is shown of the electrolytic chamber assembly shown in FIG. 1 with views of the front plate 20, right plate 21, and the top plate 22 as well as the positive terminal 30 and negative terminal 31, along with the hose barb gas fitting 32.

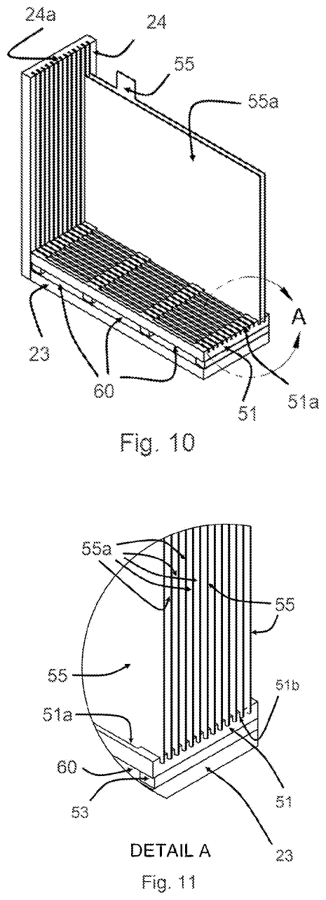

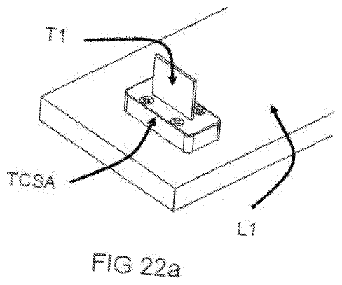

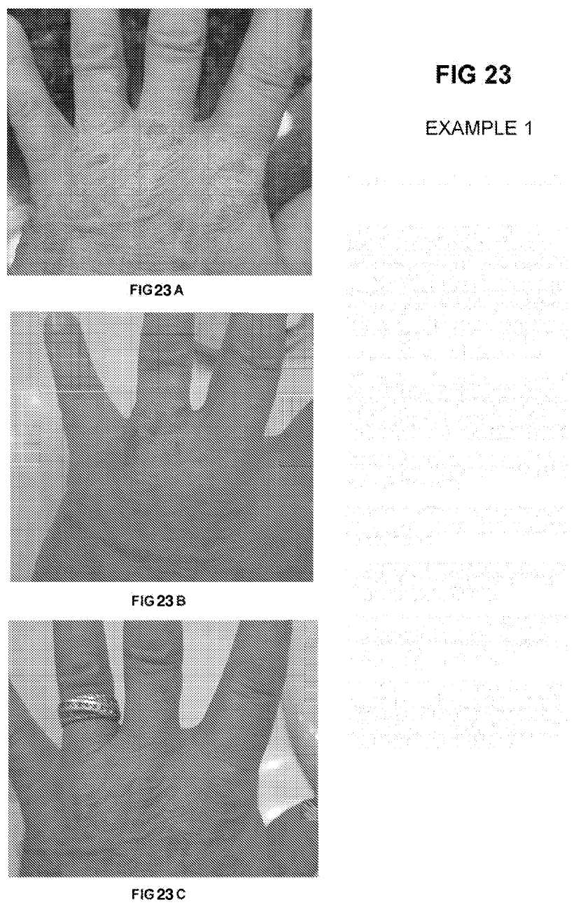

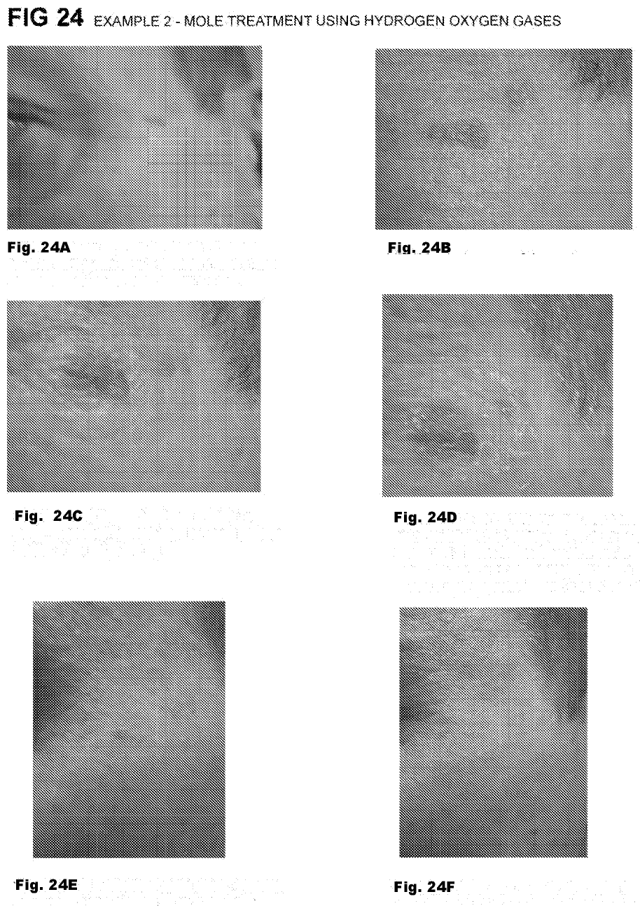

Shown in FIG. 3 is a preferred embodiment of the electrolytic container box 40 shown here as a unified molded or formed box of one piece of chemically compatible insulative media and the top panel 22 with positive terminal 30 and negative terminal 31 as well as the hose barb fitting 32. The one piece molded box 40 would be manufactured with grooves shown in FIG. 10 24a, and with similar tolerances so that the plate stack assembly shown in FIG. 6 could be fit inside and secured to prevent movement or shifting. The hose barb fitting 33 would have to be installed in a molded and threaded hole of box container 40, molded into the box container 40 as one piece, or ultrasonically or chemically welded into box 40 so as to prevent leaks. In another embodiment the square or rectangular box could be replaced with a circular, oval or spheroid container with circular plates inserted into similar grooves as shown in FIG. 22, which shows the casing partially separated for illustrative purposes, showing only partial plates inside. Also shown are molded mounting brackets.

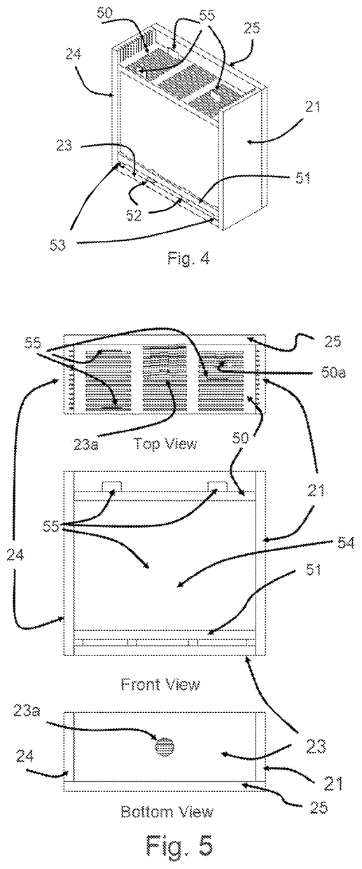

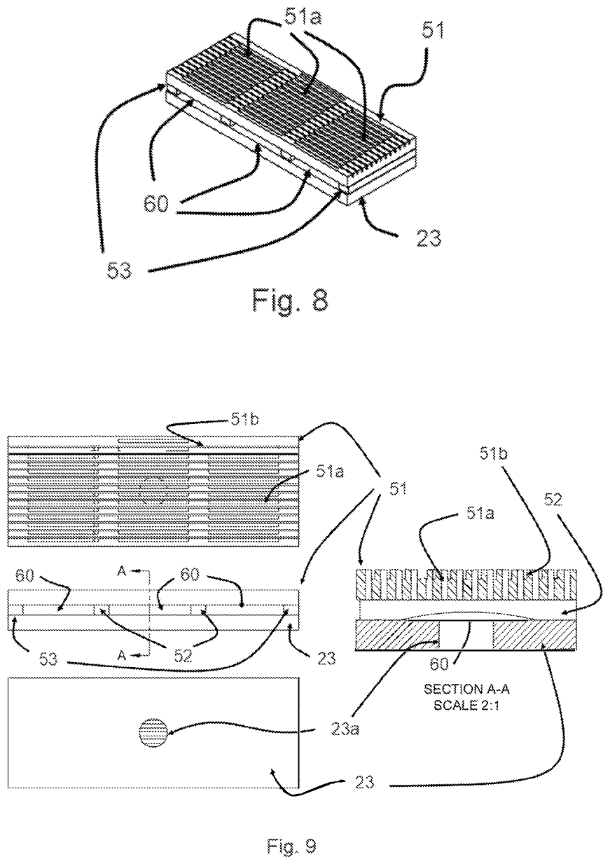

In FIG. 4 the present embodiment of the electrolytic chamber of FIG. 1 and FIG. 2 is shown with the top panel 22 and front panel 20 removed for clarity. Revealed in this isometric view are the grooves of left side panel 24 and right-side panel 21 which extend to the top of said panels to assist in the insertion of the individual metal electrode plates 55 and the metal neutral plates 55a. The grooves contained therein are manufactured with sufficient clearance to allow quick assembly, hold the plates 55 and 55a in proper parallel alignment and spacing, and allow for thermal expansion and contraction between the metal plates 55 and 55a and the plastic insulative left side panel 24 and right-side panel 21. Also shown in this view are the top plate retainer 50 and bottom plate retainer 51 which also contain similar grooving seen in left-side panel 24 and right-side panel 21. Additionally, plate retainers 50 and 51 contain additional slots 50a and 51a to allow water electrolyte solution to flow between the metal electrode plates 55 and the neutral plates SSa shown in more detail in other FIGS. Also shown in this isometric view is the bottom plate 23 upon which is placed the bottom plate retainer outer supports 53 and the inner supports 52 shown in more detail in FIG. 8 and FIG. 9.

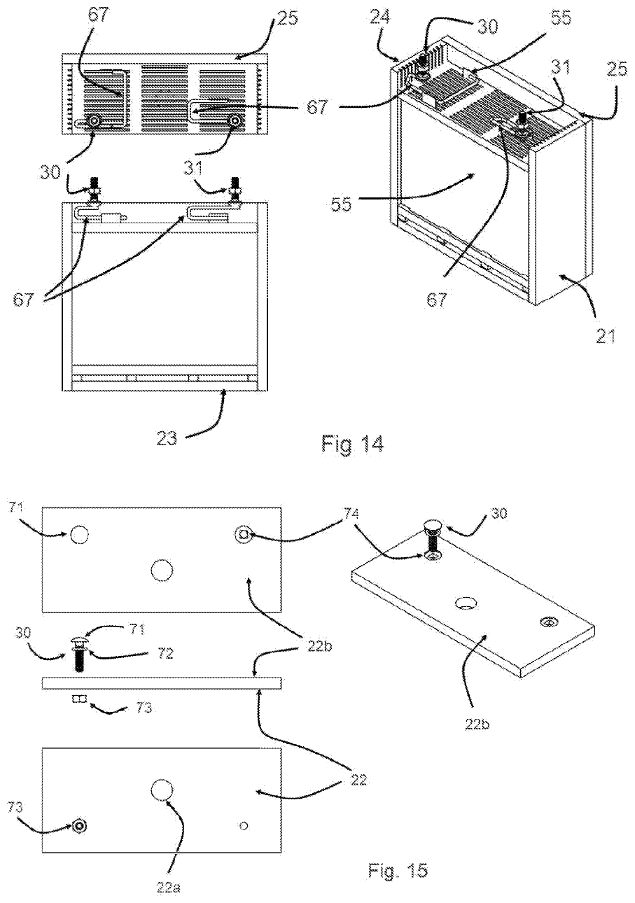

Shown in FIG. 5 are the top view, bottom view and front view of the electrolytic chamber shown in FIG. 4. The top view reveals the grooving for the metal plates 55 and SSa and the relation of the left side panel 24 and right side panel 21 to the back panel 25, and the top plate retainer 50. Also shown are the water groove slots S0a in top retainer 50, and slots in the top retainer 50 to accommodate the tabs of the metal electrodes 55, which extend up beyond the top edge of top plate retainer 50 as also seen in the front view FIG. 5. Only the electrodes 55 have tabs that extend beyond the top retainer 50 for electrical connection purposes as clarified in FIG. 13 and FIG. 14. The neutral plates SSa are not electrically connected and are nested in the grooves of left-side panel 24, right-side panel 21, lower metal plate retainer 51 and upper plate retainer 50. Also shown in the front view of FIG. 5 are the outer retainer supports 53 and inner retainer supports 52. The bottom view shows the current embodiment of FIG. 4 with the left side panel 24, right side panel 21, back panel 25 and bottom panel 23, along with the hole 23a provided for the bottom hose barb fitting 33.

In FIG. 6 is shown the isometric view of the plate stack assembly 12 containing the metal plate electrodes and tabs 55, the metal plate neutrals SSa, the upper plate retainer 50 and lower plate retainer 51, the outer retainer supports 53 and the inner retainer supports 52. Also shown is the bottom panel 23 of the electrolytic chamber for clarity of relationship with said parts. Also shown are the plate grooves S0b and S1b in the upper retainer 50 and lower retainer 51, which hold the metal plates 55 and 55a in proper alignment and spacing in conjunction with and in alignment with the side grooves of left-side panel 24 and right-side panel 21 shown in FIG. 4 and FIG. 5.

FIG. 7 includes the top view, front view, side view and bottom view of the plate stack assembly 12 shown in FIG. 6. Shown in the top view is the upper plate retainer 50 with its water slots S0a. Also seen in the top view are the metal plates 55 and SSa extending beyond the plate retainer 50. These extended plate edges are secured in the grooves of left-side panel 24 and right-side panel 21 shown in FIG. 5. Shown in the front view of the plate stack assembly 12 are the upper retainer 50, lower retainer 51, metal plate 55 and tabs 55. The bottom plate retainer 51 is placed upon the outer plate retainer supports 53 and inner plate retainer supports 52, as well as the bottom panel 23. Shown also in the front view are the water flow channels 60 in between the supports 52 and 53, which allows water electrolyte solution to be distributed and flow evenly between metal plates 55 and SSa. The side view shows the electrode metal plates 55 and their extended tabs protruding through the upper plate retainer 50, all held in proper spacing securely by the grooves S0b and S1b in upper retainer 50 and lower retainer 51. The bottom view shows the bottom panel 23 and the hole 23a for the hose barb fitting 33. The hole 23a can also be seen in the top view of FIG. 7, revealing the placement of the water flow grooves S0a which allow even distribution of the water flow 60 in through the bottom hose fitting 33, through the hole 23a and up between the metal plates 55 and SSa, passing through the water flow channels S1a and S1a.

Shown in FIG. 8 is a close up isometric view of the lower plate retainer 51, placed on the outer plate supports 53 and inner plate supports 52, which sit upon the bottom panel 23 of the electrolytic chamber assembly. Also shown are the water flow slots S1a in lower plate retainer 51, and the water flow channels 60. Alternatively, the water flow slots S1a could consist of a plurality of holes of different shapes or combination of both.

Pictured in FIG. 9 are front, top and bottom views of FIG. 8 as well as a detailed cross section view A-A. The top view and cross section view show with more clarity the precise grooving S1b in the lower plate retainer 50, which holds the plates 55 and SSa at a specific depth to hold them in alignment as well as prevent current edge leakage between the plate edges. Also seen more clearly in Section A-A are the water flow channels S1a which allows the water flow 60 between the plates without exposing the plate edges to current loss. The inner plate supports 52 are constructed to allow water to flow in through 23a, create a baffle system for even water flow, and distribute evenly across the bottom panel 23 then flow up through the water flow channels S1a between metal plates 55 and SSa. The arched flow channel of the inner retainer supports 52 and provides additional support strength of the metal plates 55 and SSa while still allowing water flow 60 across the entire length of bottom panel 23 and lower retainer 51. While the preferred embodiment of 52 is shown as arches, they could be slots, holes, or other shaped openings as long as there is sufficient water flow 60 allowed to circulate evenly between the metal plates 55 and SSa. The inner plate supports 52 also provide a type of baffle which is preferable in mobile situations where the electrolytic chamber and system are installed.

We see in FIG. 10 and detail A closeup in FIG. 11, a partial assembly of plate stack 12 along with its relation to the Left-side panel 24. In FIG. 10, only two plates are shown—an electrode plate 55 with its extended tab for electrical connection, and a metal neutral plate SSa which has no electrical connection. As can be seen in FIG. 10, the plate stack assembly sits securely in the grooves 51b of the lower plate retainer 51 and aligns with the left-side panel 24, where the grooves 24a of said panel, align with the grooves 51b of the lower plate retainer 51, allowing all plate edges to be aligned perfectly and covered to prevent edge current losses which is common in previous electrolytic chambers seen in prior art.

The close up DETAIL A in FIG. 11 is a closeup view from FIG. 10, showing the bottom panel 23 of the electrolytic chamber, an outer support 52 of the lower plate retainer 51 and metal plates 55 and 55a nested in the grooves 51b of the lower plate retainer 51. Also shown are the water slot grooves 51a in the lower plate retainer 51 and their relation to the metal plate 55. The electrolytic solution proceeds through 60, flows up through 51a and is evenly distributed across the metal plates 55 and 55a. Also indicated in FIG. 11 is a sample layout of the metal plates showing electrode 55, and 5 neutral plates 55a, then another metal electrode 55. This is a common setup in electrolytic chambers and is one preferred embodiment using a certain ratio of neutral plates to electrodes for proper voltages between the plates to create the hydrogen and oxygen gases with optimum efficiencies. Though 13 metal plates (three electrode plates 55 and ten neutral plates 55a) are shown in this preferred embodiment, this invention is not limited in scope to those numbers or ratios and the electrolytic chamber could be assembled with more neutral plates or less and be in the scope of this patent. Smaller and larger sized electrolytic chambers are easily created by increasing or decreasing the size and number of plates, retainers, and box and lid assemblies. In this embodiment, it is shown to be constructed with three electrodes 55 and ten neutrals 55a. Only the electrodes 55 are electrically connected to a power source as is well known by those skilled in the trade. In this current embodiment, two of the electrodes 55 are connected to the positive terminal 30 and one electrode 55 is connected to the negative terminal 31 as is shown in FIG. 13 and FIG. 14. In another preferred embodiment, there are equal number ratios of electrodes and neutral plates such as 4 electrodes 55 and 15 neutral plates 55a, or any multiple thereof, whether even or uneven numbers of electrodes 55.

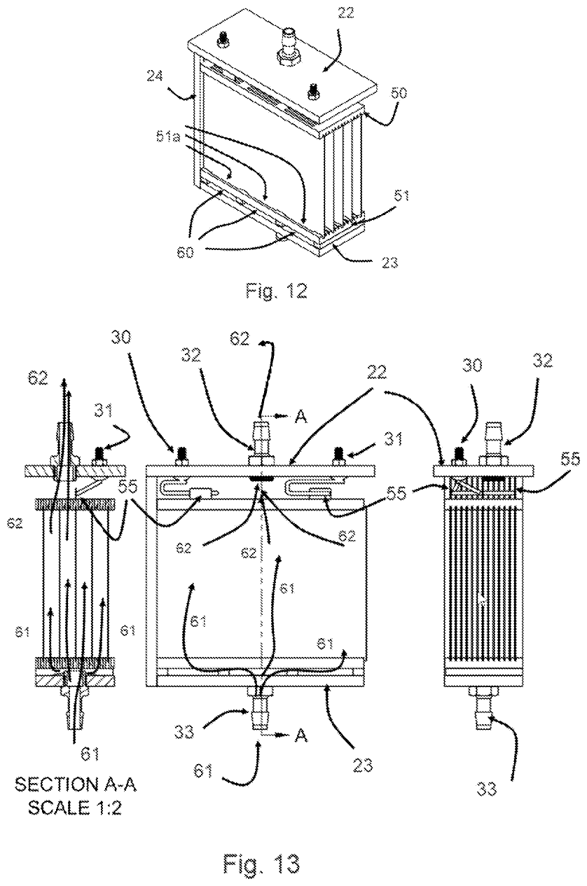

In FIG. 12, we see an isometric view of the expanded views below in FIG. 13. In FIG. 12 only the bottom panel 23, the left-side panel 24, and the top panel 22 of the electrolytic chamber container are shown for clarity. Also, only 5 metal plates (three electrodes 55 and two neutrals 55a) are shown to simplify the drawing and indicate water flow and electrical connections. We see the bottom panel 23 with its hose barb fitting 33 along with the lower plate retainer 51 and upper plate retainer 50. Water flow channels 60 indicate the chambers for water entering in through the fitting 33 and the water flow channels 51a showing the evenly distributed flow along the flat sides of the metal plates 55 and 55a.

Following along in FIG. 13, we have a front view, right side view, and a left side cross section view A-A, of the electrolytic chamber view shown in FIG. 12. In this set of views, we show a relation of the parts to both water flow and gas flow inside the electrolytic chamber assembly. The water electrolyte solution 61 enters through the bottom hose barb fitting 33 and goes up through the bottom panel 23a into the water flow channels 60 provided by the lower retainer supports 52 and 53. From there the water flow 61 evenly distributes across the area of the metal plates 55 and 55a. When voltage and current are supplied to the electrolytic chamber assembly, it flows through the positive terminal 30 and negative terminal 31 to the electrically connected tabs on metal plates 55. This connection is shown in more detail in FIG. 14.

In the exemplary embodiment the internal electrical connections are shown with a representative non-corrosive flexible wire attached from the electrode tabs to the head of the relative protruding bolt using spot welds for manufacturing efficiency. In another embodiment, the flexible wires are replaced with flexible metal strips and spot welded. In another embodiment, the spot welding is replaced by crimped connections held with bolts and nut assemblies. In another embodiment, the bolts and nuts are replaced with crimp connectors of various types attached directly to the tabs of the electrodes.

As current is applied, the voltage travels through the electrolytic solution from metal plates 55 to metal plates 55a at a rate of approximately 2 volts per space. In this embodiment, the electrical connections are such that a 12-14-volt DC power supply drives the electrolytic chamber, as is commonly equipped on vehicles. The two electrodes (positive and negative) have 5 neutral plates in between with 6 spaces at 2 volts per space. This is the preferred embodiment of a portable electrolytic system and is well known science to those skilled in the trade. As voltage and current are applied in specific pulsed frequencies to the water electrolyte solution 61, the current and voltage cause the separation of the hydrogen and oxygen covalent bonds and become a saturated gas 62 that rises up through the top plate retainer 50 and exits out through the hose barb fitting 32. This is also well-known to those skilled in the trade. In the front view and section A- A of FIG. 13 we see a simplification of the water flow 61 and the gas flow 62 relation.

Shown in FIG. 14 is a front and top view of the partial electrolytic assembly isometric view shown also in FIG. 14. The top panel 22 has been removed to better show the electrical connections of positive terminal 30 and negative terminal 31 to the metal electrodes 55. In this embodiment, the positive terminal 30 is connected to two metal electrode tabs 55 with a braided stainless steel wire 67 spot welded to each tab 55 and the head of the carriage bolt 71 which is part of the positive terminal 30 as shown in more detail in FIG. 15. The negative terminal 31 is connected to one metal electrode tab 55 with stainless steel wire 67 spot welded to the metal tab 55 and the head of carriage bolt which is part of the negative terminal connection 31. Once the wire cables 67 are spot welded to the metal tabs 55 and the carriage bolt heads 71, the carriage bolts receive a chemically resistant VITON Fluoroelastomer Rubber O-Ring 72 along with a flexible sealant and are inserted through the precisely milled openings shown in FIG. 15 in the underside 22b of the top panel 22, after which the bolts are fastened and held tightly in place by a thread locker and military grade sealing nut 73 designed to prevent leaks from fluids and gases.

In FIG. 15 the underside 22b of the top panel 22 is shown in the isometric view, top view and front view. The positive terminal assembly 30 is shown, comprised of a stainless steel carriage bolt 71, a Viton Fluoroelastomer O-ring 72, and a military grade sealing nut 73. The underside 22b of the top panel 22 is shown with a precise milling of a square hole to secure the carriage bolt 71 from turning, and a relief milled into the surface of 22b to allow compression and sealing of the Viton O-ring 72. In practice, the head of the carriage bolt 71 is spot welded to the stainless-steel braided wire 67 prior to assembly and attached to the metal tabs of electrode plates 55 prior to the plate stack assembly 12. After the plate stack assembly is inserted into the electrolytic chamber container, and all parts of the electrolytic chamber are securely welded and sealed to prevent leaks, the Viton O-rings 72 are placed on the bolts 71, a sealant is applied, and they are inserted into the milled, recessed holes 74 on the underside 22b of the top 22. The military grade sealing nuts 73 are applied with a Loctite liquid and torqued to a specific tightness so as to prevent leaks of water or hydrogen and oxygen gases. Once the positive terminal assembly 30 and the negative terminal assembly 31 are installed into the top panel 22, the top panel 22 is then prepped and sealed to the electrolytic chamber box using chemical welding, ultrasonic welding, adhesive or other chemically compatible means to seal the top 22 permanently to the electrolytic chamber box. Alternatively, the box 40 shown in FIG. 3, could be molded with inserts and the top 22 could be aligned and sealed with gasket and screws of proper dimension. Alternatively, for manufacturing purposes, a side panel could be used rather than the top panel for terminals and electrical connections.

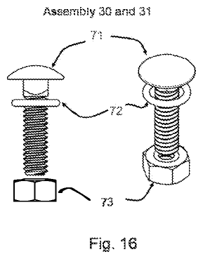

FIG. 16 shows a closeup of terminal assemblies 30 and 31 showing the stainless steel carriage bolt 71, the Viton O-ring 72, and the military grade sealing nut 73. Though terminal assemblies 30 and 31 are shown in this preferred embodiment, alternatively, the electrical terminals could consist of different metal than stainless, could be threaded or unthreaded, or formed with an alternate shape, and could be sealed into place in the top 22 and the top welded into place chemically, ultrasonically, or otherwise, similar to the terminals in a battery box that are sealed in place, though it has been the inventors experience that due to the chemical nature of the hydrogen gases produced by this type of electrolytic chamber, that gases ultimately work their way through molded terminals causing corrosion and leaks.

Therefore our preferred embodiment shown is a strong mechanical compression joint, though it is not the only embodiment available that can be used as indicated in FIG. 15 and FIG. 16. An alternative embodiment of the terminal connection, is to eliminate the stainless bolts, gaskets and sealing nut assemblies of 30 and 31 shown in FIG. 16, and extend the terminal connection 55 of the electrode, up through the box lid 22, and utilize a unique terminal compression sealing assembly shown in FIG. 22a which is fastened to the box lid with screws or similar fastening method, and which contains a groove on the underside mating surface which holds an a-ring or molded gasket which is tightly compressed against the electrode plate terminal 55 and lid 22, preventing gaseous or liquid leaks.

### Variations

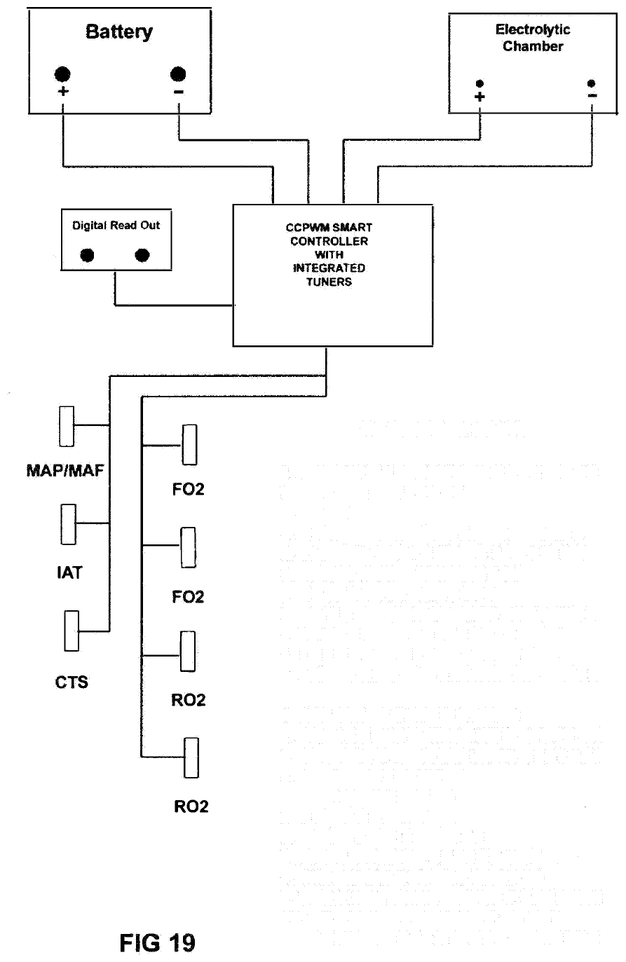

The scope of this patent details preferred embodiments of the inventors' electrolytic chamber assembly, the science behind the on-demand hydrogen-oxygen electrolyzer, which was developed by Professor Yule Brown and has been well proven by those skilled in the trade. While the use of said generators is for the most part utilized in the combustion engine sector, the inventor has discovered a complete system is needed for optimum results to achieve lower overall emissions and improved engine efficiencies, that the inventor has been successfully able to replicate and demonstrate repeatedly. A schematic and detailed operation parameters for that system is shown in FIG. 19. This said system consists of the electrolytic chamber detailed in the scope of this patent, an improved method of powering said electrolytic chamber and effective means of adjusting the sensor data sent to the vehicle ECM to adjust fuel maps accordingly as to lean out the fuel in the presence of a tuned, complete electrolytic chamber system. The typical electrolytic generators are energized by pulsed DC current provided through various, available PWM (Pulse Width Modulator) circuitry, powered by direct hookup to a 12-volt DC or 24-volt DC battery system, some of which must be manually adjusted to keep the current levels at a steady pace and prevent thermal runaway and overheating. Automated PWM's have been developed, referred to as CCPWM (Constant Current PWM) which continually monitors and adjusts the pulse rate to maintain a preset current. Some available CCPWM's are quite costly to the end user, and presently are only used to control the power presented to the electrolytic chamber, but are not able to adjust the critical sensors of modern cars, which requires yet even more circuitry/software solutions to present peak results. The Inventor has discovered over years of prototyping, manufacturing, and developing complete systems, that the most efficient data comes as a result of using an advanced CCPWM and critical engine sensor data signal adjustments for the vehicle ECM to recognize the need to lean out the combustible hydrocarbons (Gasoline, diesel, CNG, Bio-Diesel, LPG) in the presence of a hybrid fuel such as the hydrogen-oxygen gasses produced by the electrolytic chamber design covered in this patent.

The interaction between the Electrolytic chamber, the CCPWM, and the Engine sensor signal data is illustrated in FIG. 19. Currently, sensor signal data is received through hard connections to each signal wire, run through the manually controlled tuner. and adjusted carefully through trial and error for optimum results. One embodiment of this system is to integrate the manual gas or diesel tuner into the circuitry of the CCPWM, and run the wired connections directly into one circuit board, eliminating a separate board for reduced costs, and allowing pre-programmed settings to be used to reduce installation and testing times. Another embodiment eliminates the hard wiring and taps directly into the sensor data through the OBD2 diagnostics port or harness, drastically reducing installation times. Typical PWM and CCPWM systems are only designed to operate on low voltage DC 12 and 24-volt systems and are not designed for higher voltages. In another preferred embodiment of this system, the mechanism of an integrated CCPWM can be illustrated in a diagram below:

### INTEGRATED CCPWM

1. CCPWM PAULSE WIDTH MODULATOR
2. REPLACEABLE FUSE
3. RELAY
4. DIGITAL READOUT/PROGRAMMER
5. 100 AMP CAPACITY 12-30 VOLTS DC
6. ADJUSTABL FREQUENCY
7. DUTY CYCLE READOUT
8. TRIGGER WIRE SAFETY PROTOCOL
9. WATER LEVEL SENSOR-ALERT
10. OPTIONAL HEAT SENSOR-ALERT
11. TERMINAL CONNECTIONS BATT/EC

### INTEGRATED TUNER OPTIONS

1. PRESET BASIX SETTINGS FUNCTION
2. MANUAL OVERRIDE INDIV. SENSORS
3. MAP/MAF SENSORS
4. IAT-INTAKE AIR TEMP
5. CTS-COLLANT TEMP
6. UP TO 4-O2 SENSORS
7. NARROWBAND SESOR RANGES
8. WIDEBAND SENSOR RANGES
9. TERMINAL CONNCTIONS-SENSORS
10. OPTIONAL SOFTWARE DRIVEN CONNECTIONS VIA OBD PORT/HARNESS

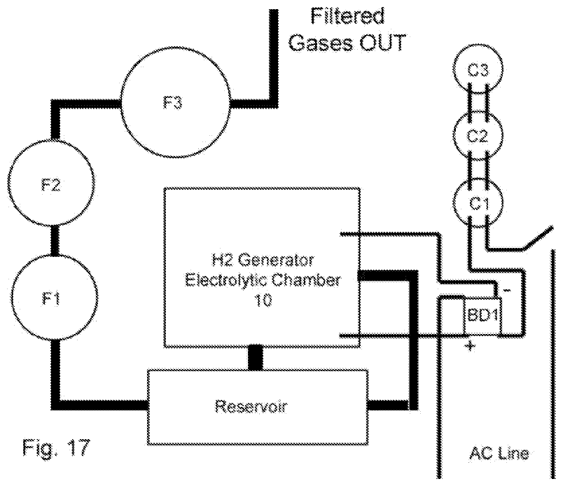

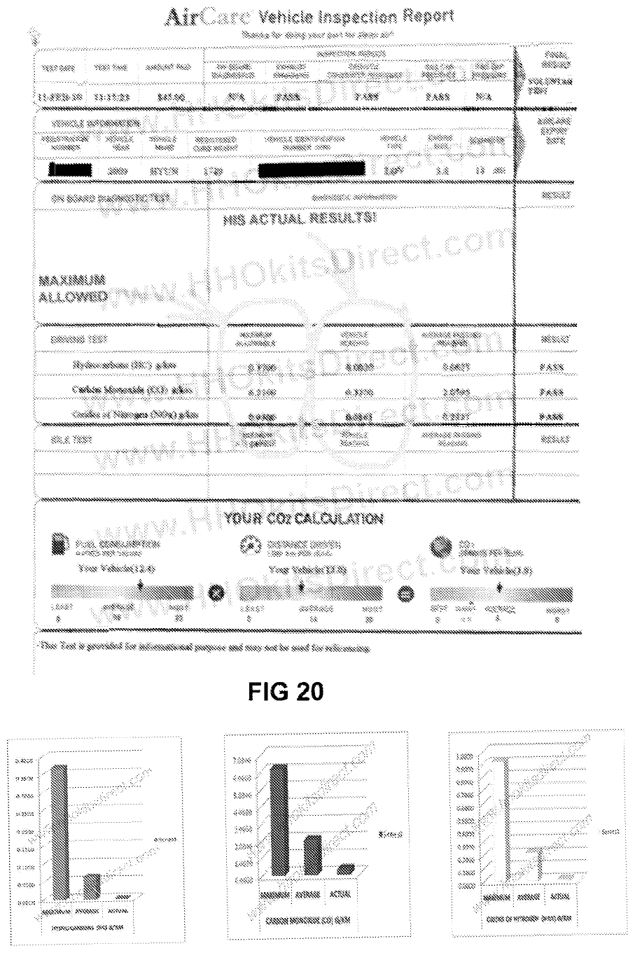

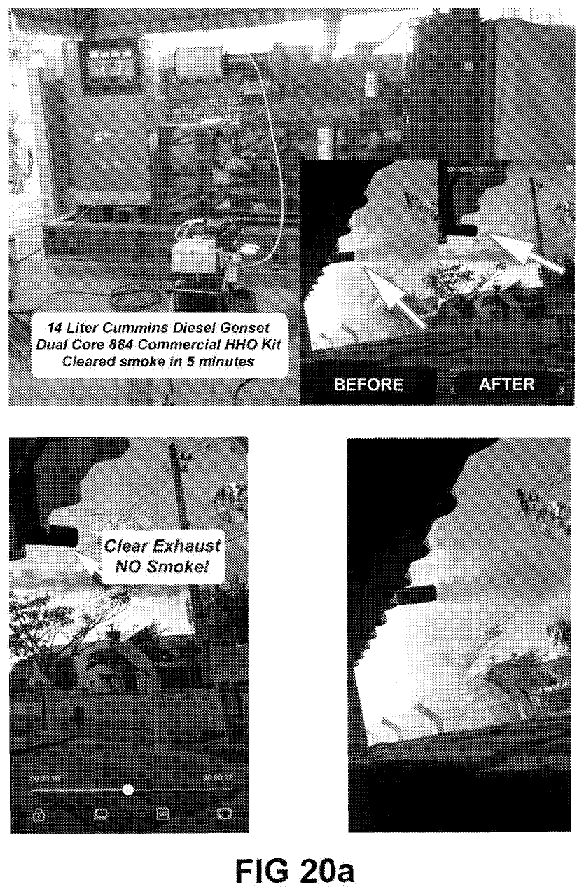

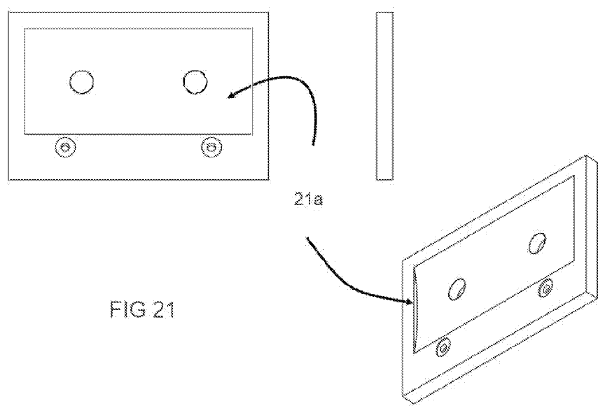

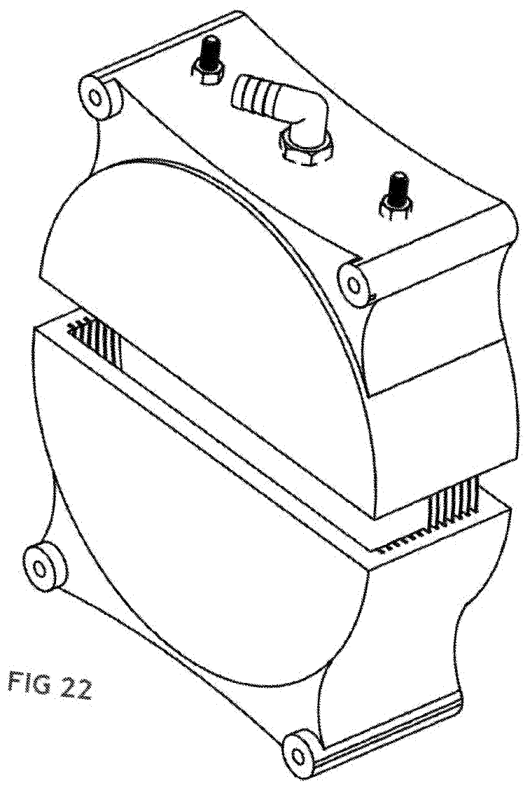

The inventor has developed advanced electrolytic systems as detailed in the embodiments of this patent, using several larger electrolytic chambers with more electrodes 55 and neutrals 55a, hooked up in series to run at higher voltages such as 48 volts, 110 volts, 220 volts and even higher. FIG. 20a shows such a configuration wired to run on 110 volts from the genset. The diesel genset was running poorly and had horrible smoke from the emissions. This dual core system was running at 110 volts/15 amps. The injected hydrogen and oxygen gases through the air filter, effectively cleared up the emissions in less than 5 minutes (live unedited video available for proof). These systems require heavy duty rectifiers to convert the output to Direct Current. There are no easily available automated controllers for the higher voltages combined with higher amperages of that nature, for extended use, outside of the laboratory setting. The inventor has developed a controller using a series of HV capacitors and circuitry which regulate the higher output wattages needed to power a larger electrolytic generator system running on 48-220 volts DC and can be engineered to run at specified Constant Current amperes without the need of an expensive programmable automated controller as seen in FIG. 17 which is a highly simplified schematic. The FI, F2, F3 are gas filtration systems needed to purify the hydrogen-oxygen gases prior to use, and are representative in number as are the HV Capacitors shown as C1, C2, and C3. In practice more or less of these components can be used to properly tune the power input. This is preferred embodiment when used on commercial generators that have higher voltages available to power larger systems and is superior to a manually adjusted variac as used on many of our POC test kits.

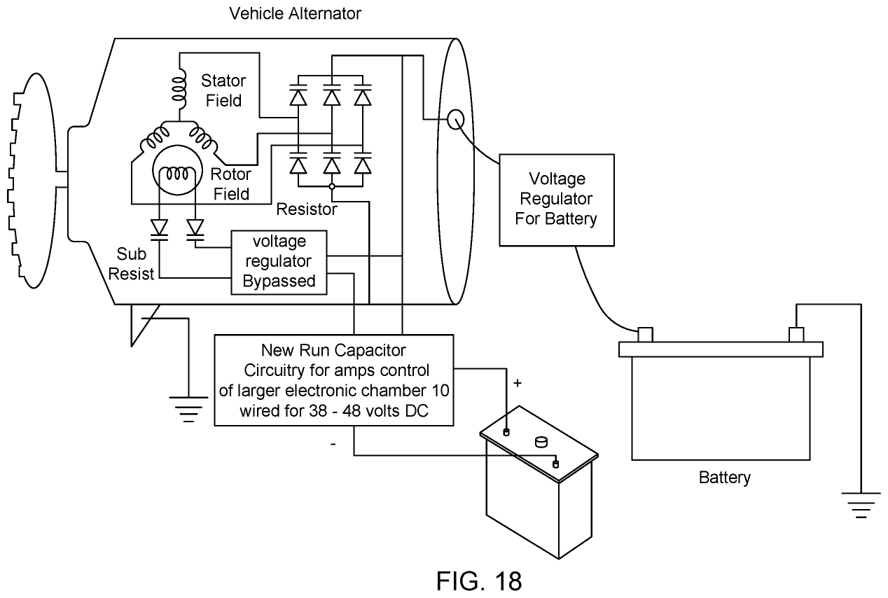

The inventor is also testing improved methods of powering the electrolytic chamber design described in this nonprovisional patent, which bypass the diode arrangement within a cars alternator and tap directly into the 3 phase AC power generated within the coils prior to the rectifier diodes and voltage regulator as seen in FIG. 18. It has been found through testing that these alternators typically generate up to 48 volts AC three phase, which is far more efficient than single phase 12 volt after it is regulated. The inventor is currently testing the ability to use that higher voltage to power the larger electrolytic chamber designs in a series arrangement to take advantage of the higher voltages using the capacitors as indicated for higher voltages, as a more powerful means to power said generators and produce higher quantities of hydrogen and oxygen gases, effectively combining the power cycles of FIG. 17 and FIG. 18.

It is also contemplated that such a setup of series wired electrolytic chambers and capacitors and circuitry, would work well in a retrofitted home heating systems to replace natural gas or LPG, and such a design with coming prototypes is being developed. The driving circuitry is roughly referred to in FIG. 17 with AC line in.

It is also contemplated that such a system running on 110 volt line power can be used to generate large quantities of combined hydrogen and oxygen gases which could be applied in the healthcare industry such as for breathing apparatus FIG. 17 to enlarge lung capacities (the inventor has personally been using this embodiment in home workouts with great success), and in topical applications to skin rashes such as eczema or psoriasis, or even wounds that are not healing under current traditional methods such as burns or diabetic ulcers with positive healing effects (also used by this inventor to treat eczema rashes on skin with good success). It is also contemplated that such a system indicated in FIG. 17, can be used to inject both fresh oxygen and hydrogen into water which appears to energize it and give a fresh taste, even eliminating the taste of plastic. The inventor has regularly used said treated water in consistent workouts, and as a regular treatment of drinking water with good results, and is developing a commercially available unit with safety protocols, digital controls, into a light and portable unit. The oxygenated water produced by the system in FIG. 17, can also be used for plants, hydroponics, gardening, animal husbandry, and other manufacturing processes.

Following FIG. 17, The electrolytic Hydrogen Generator 10 creates the hydrogen- oxygen gases which circulate through the reservoir, then out through filters F1, F2, and F3, and out for drinking water, breathing, and/or topical treatment. In one embodiment of the circuit, AC line in is 110 volts AC here but could be adapted to 220 volts AC and is only limited in scope by internal design of the electrolytic chamber 10 and controller design. The AC line is fed through a high amperage bridge rectifier and a series of capacitors is used to regulate pulsed amperage fed to the electrolytic chamber 10. The DC output of the rectifier diodes feed power to the electrolytic generator 10 and are regulated by the amount of, and the capacitive capabilities of the capacitors. FIG. 17 gives general indicators of the high wattage side (driving) of the electrical circuit, and is also used to power lower voltage accessories such as gauges and fans, etc. While electrolytically created oxygen is used widely in the healthcare industry and commercial uses such as oxygen bars, the use of an on-demand, combined hydrogen-oxygen gas has not been used in any commercial scale known by the inventor. Personal testing by the inventor has shown very interesting results in breathing the unique gases while working out in his home gym. Specifically the ability to do a full circuit workout using both aerobic and anaerobic exercises while breathing these gases (triple filtered through water filters and one micron filter), without ever being out of breath or short of breath, in spite of the inventor's age of 64. While it has been evidenced through profuse sweating that the metabolism is indeed raised and calories burnt, there is no shortness of breath or needed breaks between circuit training as is typical when not using the unique hydrogen-oxygen gases. The average workout time for the inventor testing this apparatus is 45 minutes to one hour, and there is no need to rest during the workout. Furthermore, during the use of a full body elliptical machine for cardiovascular health, the inventor has noticed and recorded his beginning heart rate vs. heart rate after accelerated training at higher paces. In many cases, the heart rate has actually dropped after 5 minutes or more of working out compared to at rest heart rates and beginning heart rates. In several examples, the inventor noted a beginning heart rate of 130-135 bpm, and after vigorous training at accelerated speeds of 70-75 rpm, heart rates were dropping to as low as 70 bpm even while sweating and working out hard. The inventor also noted that not only was BPM lower, but there was never a feeling of being out of breath or short of breath. It is therefore contemplated to engineer this prototype system into a fully developed and engineered system that could be used in gyms, health retreats and even hospitals to restore lung capacity (as in patients with covid lung), and to give athletes the ability to drive their bodies harder by utilizing this unique gas created by the electrolytic chamber described in this nonprovisional patent application.

It is also contemplated to use these higher voltage systems controlled by the capacitor circuitry for large diesel electrical power generator sets for emission reduction and running efficiencies. Rough drawings or copies of the contemplated capacitors and circuitry systems are seen in FIG. 17 and in mobile trucks or commercial vehicles of a large nature, the AC line in would be exchanged for a 12-48-volt power in and controlled by a computerized PWM system or retrofitted Alternator such as seen in FIG. 18.

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allows for “at least one” of the subject item in the description above as well as the to be appended claims. It is further noted that the to be appended claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the to be appended claims shall allow for the inclusion of any additional element irrespective of whether a given number of elements are enumerated in the to be appended claim, or the addition of a feature could be regarded as transforming the nature of an element set forth in the to be appended claims. Except as specifically defined herein, all technical and scientific terms used herein are to be given as broad a commonly understood meaning as possible while maintaining to be appended claim validity.

The breadth of the present invention is not to be limited to the examples provided and/or the subject specification, but rather only by the scope of the to be appended claim language. Use of the term “invention” herein is not intended to limit the scope of the to be appended claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Invention, etc.) be accorded special significance in describing the invention relative to another or the to be appended claims. All references cited are incorporated by reference in their entirety. Although the foregoing invention has been described in detail for purposes of clarity of understanding, it is contemplated that certain modifications may be practiced within the scope of the to be appended claims.

1. An electrolytic chamber assembly, comprising:
a) A stack of metal electrode plates;
b) Neutrals positioned between the metal electrode plates;
c) Terminal assemblies for establishing electrical connections with the electrolytic chamber assembly;
d) A top panel with precisely milled openings for securely receiving and immobilizing the terminal assemblies;
e) Sealing means, including Viton Fluoroelastomer 0-rings and military-grade sealing nuts, configured to prevent leaks;
f) Stainless steel braided wires, or formed metal strips with optional heat shrink insulation, spot welded to metal electrode tabs, forming electrical connections;
g) A method of permanently securing the top panel to the electrolytic chamber assembly, selected from the group consisting of chemical welding, ultrasonic welding, and adhesive bonding.

2. The electrolytic chamber assembly of claim 1, wherein the terminal assemblies comprise:
a) Stainless steel carriage bolts or other non reactive conductor capable of use in high alkaline environments;
b) Viton Fluoroelastomer O-rings or similar gasketing material; and
c) Military-grade sealing nuts for tightly fastening and sealing the terminal assemblies.

3. The electrolytic chamber assembly of claim 1 or 2, further comprising:
a) A CCPWM controller for regulating the supply of power to the electrolytic chamber assembly;
b) The controller utilizes capacitors and circuitry to regulate higher wattage requirements of the electrolytic chamber assembly in certain configurations.

4. A power supply system for an electrolytic chamber assembly, comprising:
a) A power source capable of providing higher voltages;
b) A controller configured to regulate the supply of power to the electrolytic chamber assembly;
c) The controller is pre-set to maintain specified amperages for safe and efficient operation.

5. The power supply system of claim 4, wherein the power source comprises:
a) A series of alternators in a vehicle or engine driven generator;
b) Said alternators generate three-phase AC power before diode regulation.

6. A method for producing hydrogen-oxygen gases using the electrolytic chamber assembly of any one of claims 1 to 3, comprising:
a) Applying power to the electrolytic chamber assembly;
b) Generating hydrogen and oxygen gases through the electrolysis of water;
c) Collecting and filtering the generated gases for various applications, including but not limited to health care, fitness, and emissions reduction.

7. The method of claim 6, wherein the electrolytic chamber assembly is powered by a power supply system according to any one of claims 4 to 5.

8. The method of claim 6 or 7, further comprising:
a) Supplying the hydrogen-oxygen gases for use in home heating systems.

9. The method of claim 6 or 7, further comprising:
a) Supplying the hydrogen-oxygen gases for use in topical applications to treat skin conditions and sub dermal applications such as but not limited to cysts, bursitis, eczema, moles, joint conditions and more.

10. The method of claim 6 or 7, further comprising:
a) Supplying the hydrogen-oxygen gases for use in health care applications to improve lung capacity and hydrogen-oxygen blood saturation levels.

11. The method of claim 6 or 7, further comprising:
a) Supplying the hydrogen-oxygen gases for use in enhancing athletic performance by athletes during workouts and recovery.

12. The method of claim 6 or 7, further comprising:
a) Supplying the hydrogen-oxygen gases for use in large diesel generator sets to reduce emissions and improve operating efficiency.

13. The method of claim 6 or 7, further comprising:
a) Supplying the hydrogen-oxygen gases to treat water for drinking.

14. The method of claim 6 or 7, further comprising:
a) Supplying the hydrogen-oxygen gases to treat water for residential, commercial, and/or industrial use including but not limited to drinking, cooking, gardening, agriculture, hydroponics, animal husbandry, fish farms, and manufacturing processes.

15. The method of claim 2, wherein the terminal connections using stainless bolts, nuts, and gaskets may be replaced with terminal compression sealing assemblies and extended stainless steel terminals extended up through the lid as the electrical connection.
